(19) United States
(12) Patent Application Publication
(10) Pub. No.: US 2015/0058045 A1
(43) Pub. Date: Feb. 26, 2015

(54) METHOD AND APPARATUS FOR INFORMATION EXCHANGE IN VEHICLES

(71) Applicant: Creative Innovation Avenue, Pine Brook, NY (US)

(72) Inventor: Thomas Santora, Holmdel, NJ (US)

(21) Appl. No.: 14/394,938

(22) PCT Filed: Mar. 29, 2013
(86) PCT No.: PCT/US13/34556

§ 371 Date: Oct. 16, 2014

Related U.S. Application Data
(60) Provisional application No. 61/687,103, filed on Apr. 18, 2012.
(60) Provisional application No. 61/791,626, filed on Mar. 15, 2013.

(51) Int. Cl. G06Q 40/08; H04W 4/02; H04W 4/00; B60R 25/102; B60R 25/33; B60R 25/32; B60Q 9/00; G06Q 50/18; B60R 25/30

(52) U.S. Cl. CPC G06Q 40/08; G06Q 50/18; H04W 4/02; H04W 4/008; B60R 25/102; B60R 25/305; B60R 25/33; B60R 25/32; B60Q 9/00; B60R 2025/1016
USPC 705/4; 455/456.1; 455/41.1; 340/426.18

(57) ABSTRACT

A system for alerting a user of a vehicle of an unexpected event, and a method for automatically exchanging ID information are disclosed. More specifically, a system and method for notifying or alerting a user of a vehicle in the event of a collision, and exchanging ID information between the vehicles involved in a collision are disclosed.

### CROSS REFERENCE TO RELATED APPLICATIONS

The present application claims benefit of U.S. provisional application Ser. No. 61/687,103, filed Apr. 18, 2012 and U.S. provisional application Ser. No. 61/791,626 filed Mar. 15, 2013, which are hereby incorporated herein by reference in their entireties.

### BACKGROUND OF THE INVENTION

1. Field of the Invention

The present invention relates generally to systems and methods for alerting a user of a vehicle of an unexpected event, and automatically exchanging ID information. More specifically, the present invention relates to systems and methods for notifying or alerting a user of a vehicle in the event of a collision, and exchanging ID information between the vehicles involved in a collision.

2. Background Art

In the past, the collection of evidence at accident scenes has always been piecemeal at best. The present technology is limited to the matching of such items as car parts, paint, etc. in order to determine the make and model of a vehicle.

Additionally, because of the split second time frames (and the trauma that can often be associated with such an event), eyewitness accounts of what transpired can either be unreliable in nature or non-existent.

To solve the above problems, the present invention employs a novel use of a present technology in the investigation of motor vehicle accidents. The technology referred to in this application is commonly known as “Mi Alerts.”

By using near field communication, it will now be possible to identify drivers who are involved in “hit and run” accidents.

More specifically, by the use of near field communication that would be left at the scene of such accidents, it will now be possible to bring to justice those who commit these “hit and run” crimes. A particularly gratifying use of this invention would be in bringing to justice those who commit the most heinous of these crimes: ones involving personal injury and death.

“Hit and run accidents in the United States have increased fifteen percent over the past five years. On average, motor vehicles are involved in 3.5 million hit and run accidents each year. According to a report compiled by the National Center For Statistics and Analysis and released by the National Highway Traffic Safety Administration on Apr. 22, 2003, hit and run accidents account for one in five pedestrian fatalities.

In related art, U.S. Pat. No. 7,119,669 relates to a portable electronic device, like a cellular telephone, capable of detecting collisions between vehicles and notifying the proper authorities. The device includes a microprocessor and memory, in addition to an accelerometer and global positioning systems receiver. The memory includes at least one filter for screening out false positives, which are false collision detections. In one embodiment, the device determines its velocity.

U.S. Pat. No. 7,317,397 relates to a method and apparatus for using RFID's in the investigation of motor vehicle accidents, which involves the use of an apparatus that would be attached to specific areas of motor vehicles. Contained within this apparatus are a plurality of (code bearing) radio frequency identifier devices or “RFID's.”

U.S. Pat. No. 7,518,490 relates to an integrated processing unit that captures range images shot by CCD cameras which are respectively provided on front, rear, left and right sides of a vehicle and image processor. Location-allocation unit creates a location-allocation model of an obstacle from the range images and road surface images (heights of images above road surface). Vehicular swept path calculating unit calculates a swept path of each representative point. Collision decision calculates intersection of the obstacle of the location-allocation model with the swept paths of the representative points and judges whether the points cross the obstacle. When a representative point may possibly cross the obstacle, the point is enhanced and displayed together with the obstacle (object) on monitor.

However, with the wide spread use of smart phones throughout the world, one would like the collision information to be readily available on his/her cell phone. There is thus a need for an improved collision notification system that is easier to install when compared to prior art systems and one that works independently, sometimes without the need of embedded vehicular subsystems.

### SUMMARY OF THE INVENTION

The present invention is an improved collision notification system that automatically gathers information pertaining to parties or vehicles involved in an accident, and sends that information to not just parties involved in the accident but also to emergency personnel who can provide assistance in a timely manner.

Accordingly, one embodiment of the present invention is a system for alerting a user of a vehicle in an unexpected event, the system including a detection means for detecting an impact to the vehicle, and a communicating means configured to send information related to the impact to a remote server and/or a mobile device. The unexpected event can be a collision by a second vehicle or a contact by a second vehicle, towing of the vehicle without authorization, or use of the vehicle without authorization. The system can further include a control means for categorizing a level of the impact according to a predetermined categorization table. The information related to the impact can include license number of the second vehicle, driver information of a driver of the second vehicle, insurance information pertaining to the second vehicle, an image of the second vehicle, a video capturing the impact, and/or a unique identification information. The driver information can include name of the driver, driver's license number and state issuing the driver's license. The insurance information can include name of an insurance company and policy number of the driver of the second vehicle. The unique identification information pertains to an identification of a second system associated with the second vehicle. The detection means can include one or more G-sensors or accelerometers. The communicating means can include a GSM unit, GPRS unit, NFC unit, and/or a Bluetooth unit. The system can also include one or more camera units configured to record images or videos of the second vehicle, and a GPS unit for determining location of the vehicle. The information related to the impact can include date of occurrence, time of occurrence, and location of occurrence of the event. The system can also include a power management means for powering the system.

Another embodiment of the present invention is an apparatus for alerting a user of a vehicle in an unexpected event, the apparatus including a detection unit for detecting an impact to the vehicle, and a communicating unit configured to send information related to the impact to a remote server. The unexpected event can be a collision by a second vehicle or a contact by a second vehicle, towing of the vehicle without authorization, or use of the vehicle without authorization. The apparatus can also include a control unit for categorizing a level of the impact according to a predetermined categorization table. The information related to the impact can include license number of the second vehicle, driver information of a driver of the second vehicle, insurance information pertaining to the second vehicle, an image of the second vehicle, a video capturing the impact, and/or a unique identification information. The driver information can include name of the driver, driver's license number and state issuing the driver's license. The insurance information can include name of an insurance company and policy number of the driver of the second vehicle. The unique identification information pertains to an identification of a second apparatus associated with the second vehicle. The detection unit can include one or more G-sensors or accelerometers. The communicating unit can include a GSM unit, GPRS unit, NFC unit and/or a Bluetooth unit. The apparatus can include one or more camera units configured to record images or videos of the second vehicle, and a GPS unit for determining location of the vehicle. The information related to the impact can include date of occurrence, time of occurrence, and location of occurrence of the event. The apparatus can also include a power management unit for powering the apparatus.

Another embodiment of the present invention is a method for alerting a user of a vehicle in an unexpected event, the method including a detection step for detecting an impact to the vehicle, and a communicating step for sending information related to the impact to a remote server and/or a mobile device. The unexpected event can be a collision by a second vehicle or a contact by a second vehicle, towing of the vehicle without authorization, or use of the vehicle without authorization. The method can also include a control step for categorizing a level of the impact according to a predetermined categorization table. The information related to the impact can include license number of the second vehicle, driver information of a driver of the second vehicle, insurance information pertaining to the second vehicle, an image of the second vehicle, a video capturing the impact, and/or a unique identification information. The driver information can include name of the driver, driver's license number and state issuing the driver's license. The insurance information can include name of an insurance company and policy number of the driver of the second vehicle. The unique identification information pertains to an identification associated with the second vehicle. The information related to the impact can include date of occurrence, time of occurrence, and location of occurrence of the event.

Another embodiment of the present invention is a computer readable program recorded on a non-transitory computer readable medium for executing a detection step for detecting an impact to the vehicle, and a communicating step for sending information related to the impact to a remote server and/or a mobile device. The unexpected event is a collision by a second vehicle or a contact by a second vehicle, towing of the vehicle without authorization, or use of the vehicle without authorization. The program can include a control step for categorizing a level of the impact according to a predetermined categorization table. The information related to the impact can include license number of the second vehicle, driver information of a driver of the second vehicle, insurance information pertaining to the second vehicle, an image of the second vehicle, a video capturing the impact, and/or a unique identification information. The driver information can include name of the driver, driver's license number and state issuing the driver's license. The insurance information can include name of an insurance company and policy number of the driver of the second vehicle. The unique identification information pertains to an identification associated with the second vehicle. The information related to the impact can include date of occurrence, time of occurrence, and location of occurrence of the event.

Yet another embodiment of the present invention is a non-transitory computer readable medium comprising the computer readable program according to the previous embodiment.

Terms “comprising” and “comprises” in this disclosure can mean “including” and “includes” or can have the meaning commonly given to the term “comprising” or “comprises” in US Patent Law. Terms “consisting essentially of” or “consists essentially of” if used in the claims have the meaning ascribed to them in U.S. Patent Law. Other aspects of the invention are described in or are obvious from (and within the ambit of the invention) the following disclosure.

### BRIEF DESCRIPTION OF DRAWINGS

The accompanying drawings, which are included to provide a further understanding of the invention, are incorporated in and constitute a part of this specification. The drawings presented herein together with the description serve to explain the principles of the invention. In the drawings:

FIG. 1 is a schematic view of a system according to one embodiment of the present invention;

FIG. 2 is a schematic view of an apparatus, according to one embodiment of the present invention;

FIG. 3 is a schematic view of a system, according to one embodiment of the present invention;

FIG. 4 depicts steps involved in an information processing method, according to one embodiment of the present invention; and

FIG. 5 depicts an impact classification table, according to one embodiment of the present invention.

### DETAILED DESCRIPTION

The invention according to one exemplary embodiment is a communication system that utilizes sensors, a microprocessor/microcontroller, a memory device, and an online server, whereby information is captured and exchanged between these sensors, and transmitted via a wireless connection to an online server.

According to one exemplary embodiment, sensors may be placed within the bumpers and doors of automobiles, such as passenger cars. When any part of a vehicle that is equipped with the present system hits or bumps another vehicle equipped with the same type of system, whether it be bumper to bumper, door to door, or bumper to door, etc., these sensors can detect the impact and exchange information with one another.

According to the embodiments of the present invention these sensors will not only be able to exchange information to one another but also be able to detect the level of impact of the collision, thus identifying the extent of the damage inflicted by the other car. Each sensor can have its own unique identification (along with additional information, if necessary) that can be transmitted to the other sensor when impact takes place. Once this exchange of identification or information occurs between the sensors, it can then be transmitted via a wireless connection to the vehicle's operating system, while simultaneously being sent to a secure, online server.

Capturing, exchanging and transmitting information by these sensors and establishing a communication system in order to facilitate and secure this information is the primary objective of the present invention.

The various embodiments in the present invention can be equipped with:
G-sensors (to measure impact)
GSM modem (to post all information online to a website)
Bluetooth module (to offer the information to a mobile device or an automobile computer installed within the vehicle)
NFC module (for bump detection and ID exchange) and/or
A GPS chip (embedded within the system for tracker information)

Using the various embodiments of the present invention, a person will be able to identify another automobile if their vehicle is struck by that automobile. This function will be primarily utilized when someone is the victim of a hit and run (while parked or in transit) or when damage is done to their car by another's car door from impact while opening. The various embodiments of the present invention will be able to identify that vehicle through this system.

According to one embodiment, the various embodiments of the present invention are suitable for automobiles whose basic function is to transmit information when a car accident occurs through a sensor located, for example, directly behind a car's front license plate. The various embodiments of the present invention use a sensory board that detects impact and movement, and sends that information to an online server, as well as the owner's mobile device, for example.

If only one car in the accident has the system or apparatus according to the present invention, then an alert is sent to that owner's mobile device informing him/her that their car was bumped, dinged (by another car door) or smashed (by another car). The system or apparatus is able to measure the degree of impact of the collision as well. However, if both cars in the accident have the system or apparatus, then an alert is sent to both owner's mobile device, and the information of each driver (in the form of an identification number, for example) is exchanged between both drivers, along with being sent to an online secure database, where both drivers can be identified and thus eliminating all “hit and run” accidents.

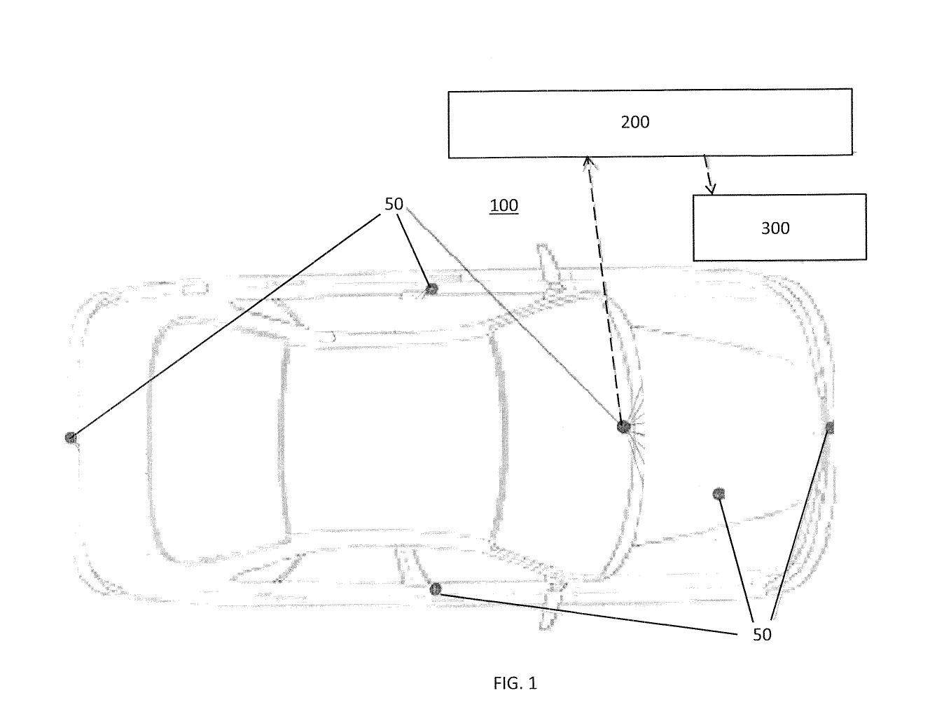

Turning now to the figures, FIG. 1 is a schematic view of a system 100 according to one embodiment of the present invention. As illustrated in FIG. 1, an information processing apparatus 50 can be deployed on a vehicle, for example, a passenger car, according to one embodiment of the present invention. The various components of the apparatus 50 will be described in detail in the following paragraphs, however, as one skilled in the art can envision, any and all of the components of the apparatus 50 can be integrated into a vehicle to improve the aesthetics and/or performance of the apparatus. As described herein, an “apparatus” refers to an apparatus that works independently, without the need of embedded vehicular subsystems. A “system” as referred to herein refers to a system that is embedded within the vehicular subsystems, for example within a microprocessor or operating system of a vehicle, such as an automobile. Although the present invention applies to both variations, the use of these terms will be clear based on the context within the description.

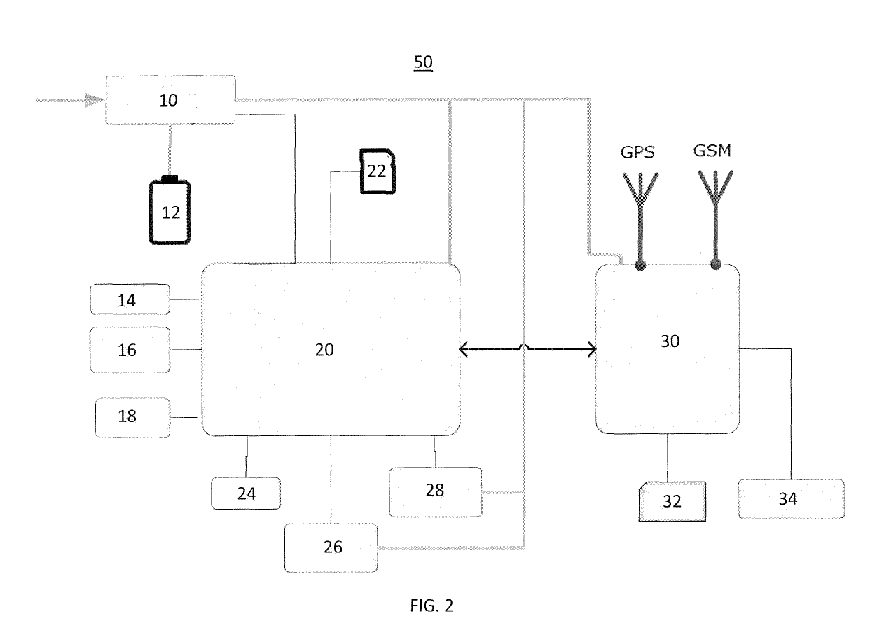

As shown in FIG. 1, a plurality of information processing apparatuses 50 can be distributed throughout a vehicle. Preferred locations are on top of the license plates on the front and/or the back, on the side doors, front and/or back, on the fenders in the front and/or back of the vehicle, and one in the center of the wind shield. A top level hardware design of each of the apparatuses 50 is shown in FIG. 2, for example. As shown in this figure, apparatus 50 includes a power management module 10, which receives power supply from a power source, from the car battery or a 12V mains supply, for example. The power management module 10 can be connected to a backup battery 12, such as a Lithium ion battery (100 mAH-1000 mAH), for example, which can be used in the event of a loss in power in the car. The power from the power management module 10 mainly supplies power to the control module 20, which may be a microcontroller or a microprocessor suitable for the purpose; STM32F103RBT6 from ST Microelectronics being one example. Control module 20 performs the basic functions of a microcontroller or a microprocessor, i.e. getting data from the sensors connected to it and processing them so that data can be used in further processes. The power from the power management module 10 also powers a G-sensor or accelerometer 28, which is an important element of the present invention. Accelerometer 28 is the device that detects the impact when another vehicle or object comes in contact with the present vehicle or at least slightly dings any portion thereof. As shown in FIG. 2, the power management module 10 also powers a Near Field Communication (NFC) or Bluetooth® module 26, which is capable of connecting to a mobile device (not shown) or any device equipped with a NFC or Bluetooth® capability.

Another important element of the apparatus 50 is the communication module 30, which can include GSM, GPRS, and GPS capabilities, for example. The communication module 30 collects information from the control module 20 and wirelessly transmits this information to the nearest cell phone tower. The information transferred from the communication module can be transferred to any remote server, which can be accessed using a smart phone application or any computer connected to the internet. Since the communication module also includes GPS capabilities, information pertaining to the global positioning of the vehicle can also be transmitted to the remote server. Any GPS, GSM antenna connector known to one of ordinary skill in the art may be used in this case, for example, a cable of U.FL to SMA connector may be used. Similarly, any external or internal SMA GPS/GSM antenna can be plugged from outside of the apparatus 50, for example.

It should be noted, however, that since the apparatus 50 includes a Near Field Communication (NFC) or Bluetooth® module 26, the information collected by the control module 20 can be readily transmitted to a device closest to it, for example, a person's cell phone with a Near Field Communication (NFC) or Bluetooth® capability. NFC may be preferred, in some instances, over Bluetooth®, however, because NFC does not require prior pairing.

The communication module 30, which includes a SIM card 32, such as a mini or micro SIM card, for example, can have a hinged type connector to hold the SIM card 32. The communication module 30 can also include LED lights 34 to indicate successful transmission of information (green light, for example), and unsuccessful transmission (red light, for example) when the transmission to the server and/or the mobile device is not successful. One example of a LED that may be used is a 12V GPS lock, GSM status, GSM netlight type LED.

According to one embodiment, the control module 20 can include a volatile or non-volatile memory device 22, such as a micro SD card, which can temporarily or permanently store information related to the collision. The control module 20 can also be connected to a DIP switch 14, with 8 selectable switches for select SD card logging (on or off) and five selectable reporting periods, for example. The control module 20 can also be attached to an external interface 16, which can indicate a car engine state, for example, using a 2 input pin 12V (max) and 2 ADC input pin 12V (max). The control module 20 can additionally be connected to a Joint Test Action Group (JTAG) 24, which is a microcontroller programming interface.

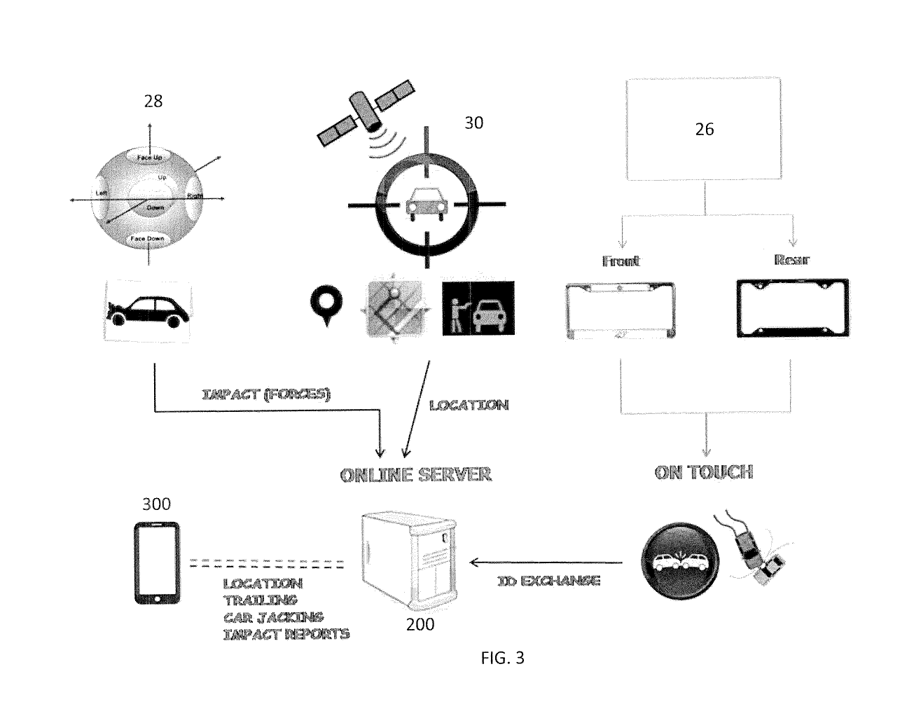

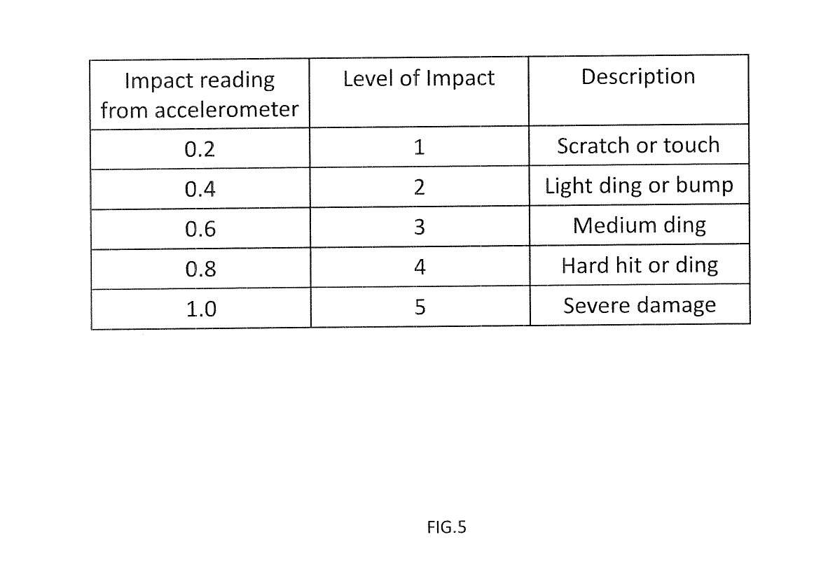

Turning now to FIG. 3, in there is shown a schematic of how the apparatus 50 works in the unexpected event of a collision. In the event of a collision or an unexpected contact by another vehicle, as shown in the bottom right corner of the figure, for example, accelerometer 28 senses the impact or forces experienced by the vehicle, and sends the information to the control module 20. The control module 20 categorizes the impact reading from the accelerometer 28 according to a predetermined table, such as for example that shown in FIG. 5. As shown in FIG. 5, different readings from the accelerometer can indicates different levels of impacts, which can indicate different levels of accidents. For example, a reading of 0.2 from the accelerometer would be categorized as a level 1 impact, which could mean a scratch or touch by another vehicle or object. Similarly, a reading of 0.4 from the accelerometer would be categorized as a level 2 impact, which could mean a light ding or bump by another vehicle or object. Similarly, a reading of 0.6 from the accelerometer would be categorized as a level 3 impact, which could mean a medium ding or bump by another vehicle or object. Similarly, a reading of 0.8 from the accelerometer would be categorized as a level 4 impact, which could mean a hard hit or ding by another vehicle or object. Similarly, a reading of 1.0 from the accelerometer would be categorized as a level 5 impact, which could indicate a severe damage to the vehicle.

The level of impact information and the information about the amount of damage done to the vehicle can be sent directly from the control module 20 to a mobile device, such as a cell phone or a smart phone via the Near Field Communication (NFC) or Bluetooth® module 26. Alternatively, this information can be sent to the communication module 30, which now also has the location information (GPS reading) using the GPS chip.

According to one embodiment, the Near Field Communication (NFC) or Bluetooth® module 26 can be mounted on the front and/or rear license plates of the vehicle and it can exchange information related to the impact with the other vehicle. The information related to the impact can include, for example, license number of the second vehicle, driver information of a driver of the second vehicle, insurance information pertaining to the second vehicle, an image of the second vehicle, a video capturing the impact, and/or a unique identification information. The driver information can include name of the driver, driver's license number and state issuing the driver's license. The insurance information can include name of an insurance company and policy number of the driver of the second vehicle. The unique identification information pertains to an identification of a second apparatus associated with the second vehicle. The information related to the impact can include date of occurrence, time of occurrence, and location of occurrence of the event. Any and all of this information can now be collected by the communication module 30 from the control module 20 and sent to a remote server 200 using, for example, the closest tower, or can be sent to a mobile device 300 directly. Although the various embodiments described herein refer to the use of a car and the unexpected event being a collision, the application of the present invention is not so limited. For example, the unexpected event can be a collision by a second vehicle or a contact by a second vehicle, towing of the vehicle without authorization, or use of the vehicle without authorization.

According to one embodiment, the various embodiments of the present invention can include one or more cameras, which can be located in any part of the vehicle, but preferably located right above the license plate in the front and/or the rear. The various embodiments of the present invention can include two or more additional, small, remote cameras that can be strategically placed throughout the vehicle, for example, above the back license plate and on each door. When an accident occurs, the impact will trigger each camera to take a picture immediately after the collision, thus capturing a snapshot of the other car in the accident. According to one embodiment, the camera will also be able to take a short streaming video (as well as a picture) upon impact (sensor will trigger the camera to start recording and to take a picture).

According to one embodiment, the information related to the impact can be uploaded to a server 300 via the communication module 30, and then this information can be downloaded via a mobile device 200, for example a cell phone, which may be quipped with the application necessary to download this information, Alternatively, the information related to the impact can be can be sent directly from the control module 20 to a mobile device, such as a cell phone or a smart phone via the Near Field Communication (NFC) or Bluetooth® module 26.

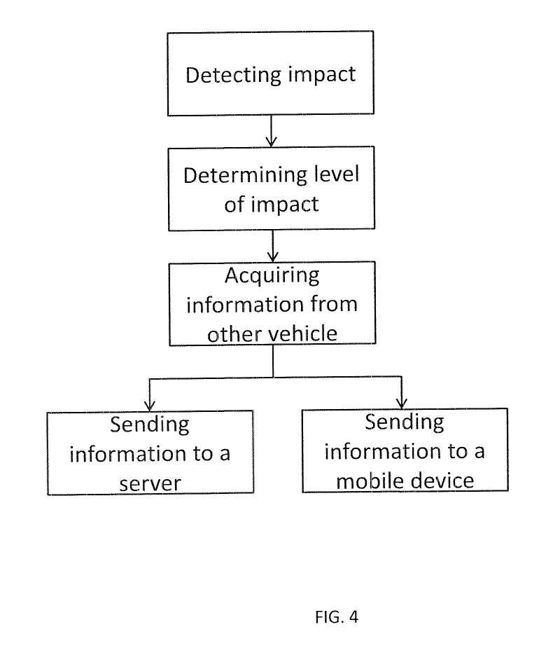

Another embodiment of the present invention is a method for alerting a user of a vehicle in an unexpected event, for example, that shown in FIG. 4. The method includes a detection step for detecting an impact to the vehicle, a determining step for determining the level of impact, an acquiring step for acquiring relevant information from the other vehicle, and a communicating step for sending information related to the impact to a remote server and/or a mobile device. The method can also include a control step for categorizing a level of the impact according to a predetermined categorization table, such as that shown in FIG. 5, for example.

Another embodiment of the present invention is a computer readable program recorded on a non-transitory computer readable medium for executing the method described in the previous embodiment. Yet another embodiment of the present invention is a non-transitory computer readable medium comprising the computer readable program according to the previous embodiment. The computer readable medium may or may not be a part of the vehicular subsystems, such as the microprocessor or operating system within the vehicle. Additionally, although the various embodiments refer to a vehicle, such as a car, the invention is not limited as such. The systems, methods, and apparatuses described herein can be applied to any automobile including trucks, minivans, SUVs and the like.

Additional features various embodiments of the present invention include a built-in GPS that allows one to find his/her car in a crowded parking lot, the system alerts the user if his/her car is getting towed, alerts the user if his/her teenager is taking the car without prior permission, and alerts the user if his/her car is being stolen (if car is on the move without authorization or the system power is cut). The various embodiments of the present invention also alert the user if he/she cannot find their keys, and come with additional features such as a child finder, and/or a pet finder.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as, an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1.-13. (canceled)

14. An apparatus for alerting a user of a vehicle in an unexpected event, the apparatus comprising:
a detection unit for detecting an impact to the vehicle; and
a communicating unit configured to send information related to the impact to a remote server.

15. The apparatus according to claim 14, wherein the unexpected event is a collision by a second vehicle or a contact by a second vehicle, towing of the vehicle without authorization, or use of the vehicle without authorization.

16. The apparatus according to claim 14, further comprising a control unit for categorizing a level of the impact according to a predetermined categorization table.

17. The apparatus according to claim 15, wherein the information related to the impact comprises license number of the second vehicle, driver information of a driver of the second vehicle, insurance information pertaining to the second vehicle, an image of the second vehicle, a video capturing the impact, and/or a unique identification information.

18. The apparatus according to claim 17, wherein the driver information comprises name of the driver, driver's license number and state issuing the driver's license.

19. The apparatus according to claim 17, wherein the insurance information comprises name of an insurance company and policy number of the driver of the second vehicle.

20. The apparatus according to claim 17, wherein the unique identification information pertains to an identification of a second apparatus associated with the second vehicle.

21. The apparatus according to claim 14, wherein the detection unit comprises one or more G-sensors or accelerometers.

22. The apparatus according to claim 14, wherein the communicating unit comprises a GSM unit, GPRS unit, NFC unit and/or a Bluetooth unit.

23. The apparatus according to claim 15, further comprising one or more camera units configured to record images or videos of the second vehicle.

24. The apparatus according to claim 14, further comprising a GPS unit for determining location of the vehicle.

25. The apparatus according to claim 14, wherein the information related to the impact comprises date of occurrence, time of occurrence, and location of occurrence of the event.

26. The apparatus according to claim 14, further comprising a power management unit for powering the apparatus.

27. A method for alerting a user of a vehicle in an unexpected event, the method comprising:
a detection step for detecting an impact to the vehicle; and
a communicating step for sending information related to the impact to a remote server and/or a mobile device.

28. The method according to claim 27, wherein the unexpected event is collision by a second vehicle or a contact by a second vehicle, towing of the vehicle without authorization, or use of the vehicle without authorization.

29. The method according to claim 27, further comprising a control step for categorizing a level of the impact according to a predetermined categorization table.

30. The method according to claim 28, wherein the information related to the impact comprises license number of the second vehicle, driver information of a driver of the second vehicle, insurance information pertaining to the second vehicle, an image of the second vehicle, a video capturing the impact, and/or a unique identification information.

31. The method according to claim 30, wherein the driver information comprises name of the driver, driver's license number and state issuing the driver's license.

32. The method according to claim 30, wherein the insurance information comprises name of an insurance company and policy number of the driver of the second vehicle.

33. The method according to claim 30, wherein the unique identification information pertains to an identification associated with the second vehicle

34-36. (canceled)
